(19) United States
(12) Patent Application Publication
(10) Pub. No.: US 2014/0340326 A1
(43) Pub. Date: Nov. 20, 2014

(54) DRAWING APPARATUS AND DRAWING SYSTEM

(71) Applicant: KABUSHIKI KAISHA TOSHIBA, Tokyo (JP)

(72) Inventors: Kenichi KAMEYAMA, Setagaya-ku (JP); Daisuke YAMAMOTO, Kawasaki-shi (JP); Junya TAKAKURA, Kawasaki-shi (JP)

(73) Assignee: KABUSHIKI KAISHA TOSHIBA, Tokyo (JP)

(21) Appl. No.: 14/194,421

(22) Filed: Feb. 28, 2014

(30) Foreign Application Priority Data
May 14, 2013 (JP) 2013-102616

(51) Int. Cl. G06F 3/0354; G06F 3/16; G06F 3/038; G06F 3/01

(52) U.S. Cl. CPC G06F 3/03545; G06F 3/016; G06F 3/16; G06F 3/0383
USPC 345/173; 345/179

(57) ABSTRACT

According to an embodiment, a drawing apparatus includes a casing including a tip; and a drive unit configured to vibrate the drawing apparatus. The drive unit is positioned within a range of 10 to 80 mm from the tip.

### CROSS-REFERENCE TO RELATED APPLICATION(S)

This application is based upon and claims the benefit of priority from Japanese Patent Application No. 2013-102616, filed on May 14, 2013; the entire contents of which are incorporated herein by reference.

### FIELD

Embodiments described herein relate generally to a drawing apparatus and a drawing system.

### BACKGROUND

In a mobile terminal such as a tablet, there is known a technology in which when an operation is performed by directly touching a screen with a finger or a touch pen, adequate vibration is given to develop a tactile sense of drawing in a pseudo manner. For example, there is known a technology in which when a user moves his or her finger along a screen surface, adequate vibration is added on a screen in a horizontal direction so that a user experiences a tactile feeling approximated to that of a concavo-convex shape. Also, there is promoted a method in which a tactile sense is utilized to provide a feedback to an action of operating a button on a screen or to present an end or a specific area on a screen.

In these technologies, vibration caused by friction between a paper sheet and a touch pen has been attempted to be realized in a contact part between a pen tip and a screen. However, with a pen tip vibrated during drawing, a drawn line can be jagged when attempting to draw a smooth line.

### BRIEF DESCRIPTION OF THE DRAWINGS

FIG. 1 is a diagram illustrating a hardware configuration of a drawing apparatus according to an embodiment;

FIG. 2 is a flow chart illustrating a flow of processing for controlling vibration of a touch pen according to an embodiment;

FIGS. 3A and 3B are diagrams for explaining vibration received by a touch pen during drawing;

FIG. 4 is a diagram illustrating a positional relationship between a touch pen and a hand;

FIG. 5 is a diagram illustrating an example of an arrangement aspect of a drive unit according to an embodiment;

FIG. 6A is a diagram illustrating an arrangement aspect of a drive unit in a touch pen according to an embodiment; and FIG. 6B is an enlarged view of a touch pen and a drive unit;

FIG. 7A is a diagram illustrating another example of an arrangement aspect of a drive unit in a touch pen according to an embodiment; and FIG. 7B is an enlarged view of a touch pen and a drive unit;

FIGS. 8A to 8C are diagrams for explaining a position of disposing a drive unit of a touch pen according to an embodiment;

FIG. 9 is a diagram illustrating characteristics of an organ receptor of a tactile sense on hand skin;

FIG. 10 is a diagram illustrating human auditory characteristics;

FIGS. 11A and 11B are diagrams illustrating power of vibration generated when drawing is performed with a pencil and a ballpoint pen;

FIG. 12 is a diagram illustrating drawing areas on a screen of a drawn apparatus according to an embodiment;

FIG. 13A is a graph illustrating a spectrum of sound actually generated between a pencil and a paper sheet;

FIG. 13B is a graph illustrating a spectrum of sound actually generated between a ballpoint pen and a paper sheet;

FIG. 14A is a graph illustrating loudness changes for brush-moving speeds;

FIG. 14B is a graph illustrating loudness changes for frequencies;

FIG. 15 is a diagram illustrating an entire configuration of another drawing apparatus according to an embodiment;

FIGS. 16A and 16B are diagrams illustrating a relationship between a favorable writing feeling of a touch pen, and experienced friction; and

FIG. 17 is a diagram illustrating an example of a calculation unit of a drawing apparatus according to each embodiment.

### DETAILED DESCRIPTION

According to an embodiment, a drawing apparatus includes a casing including a tip; and a drive unit configured to vibrate the drawing apparatus. The drive unit is positioned within a range of 10 to 80 mm from the tip.

In general, letters or figures are drawn by bringing a pen in contact with a glass surface such as a tablet (hereinafter, simply referred to as drawing), but a pen is likely to slip on a glass surface, resulting in an uncomfortable writing feeling. As a countermeasure to this, for example, an elastomer (such as vulcanized rubber), felt, or the like is used as a material of a pen tip; or a resistance sense-enhancing film is applied on a glass surface such as a tablet.

Furthermore, there exists a technology enabling a user to experience a friction sense when moving a finger along a screen. Thus, a friction sense during an action of moving a finger along a screen is realized. Similarly, in a case of a pen tablet type interface, a technology is known in which surface elastic waves by ultrasonic waves are generated on a screen side to provide resistance in a pen moving direction. Accordingly, roughness is realized. In this case, when vibrating a screen by surface elastic waves in a moving direction of a touch pen and in an opposite direction to the moving direction of a touch pen, easiness and difficulty of movement with respect to a touch pen movement alternately appear. This is sensed as friction. Besides, there are known a method of realizing an adequate friction sense by changing screen vibration strength according to an area of a touch pen being in contact with a screen, as well as a method of calculating vibration behaviors caused by friction between a paper sheet and a touch pen by a simulation and transmitting a similar vibration to a touch pen by vibration of a screen. Moreover, there is disclosed a stylus in which a rotating vibrator or a linear vibrator is vibrated in response to vibration control information from external sources, and the vibration is modulated according to a moving speed of a pointer.

However, when a pen tip vibrates during drawing, a drawn line becomes jagged, and a smooth line is difficult to be drawn. Furthermore, there are two locations where a pen and a hand are in contact with each other while a pen is held. The two locations are a part on a pen held by a finger (a contact point 1) and a part for stabilizing a writing material (a contact point 2). According to ergonomic evaluation, there is knowledge that the center of gravity of a pen having a favorable writing feeling is advantageously located near the contact point 2. Such knowledge is described in Nobuki Matsuzaki, Shigeru Kinoshita, Ko Kayama, and Sachiko Tone, About Writing Feeling of Writing Material, Extended Abstracts of The 47th Meeting of The Japan Society of Applied Physics and Related Societies, 2000, p 460. That is, for improving a writing feeling during drawing, vibration of a pen tip is desirably transferred to the contact point 1 while inhibiting vibration from being transferred to the contact point 2 that is a location for stabilizing a writing material. However, a pen having such characteristics has not been developed. Here, vibration to be transferred to the contact point 1 may be only information on whether or not figures and letters are being drawn with a touch pen. For example, unnecessary processing such as modulation of vibration according to a writing speed has been substituted. Therefore, embodiments described herein provide a drawing apparatus capable of inhibiting drawing from becoming difficult to be performed due to vibration.

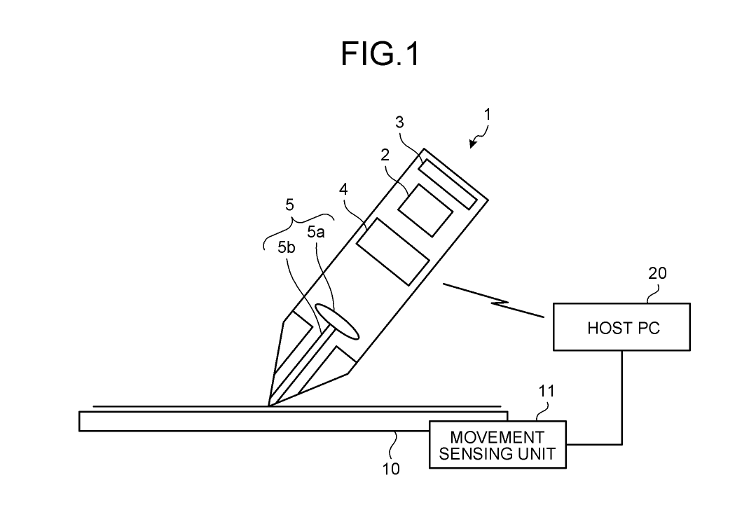

A drawing apparatus according to an embodiment described herein will be described below with reference to drawings. FIG. 1 is a diagram illustrating a hardware configuration of a drawing apparatus. As illustrated in FIG. 1, a drawing apparatus 1 includes a drive unit 2, a power source 3, a calculation unit 4 (a drive controller), and a contact sensing unit 5. A touch pen that is an example of an interface apparatus for a tablet will be described below as an example of a drawing apparatus. A touch pen 1 is a device making a drawing on a screen of a drawn apparatus 10 such as a digitizer. The drawn apparatus 10 includes a movement sensing unit 11 that detects coordinates, on which a drawing is performed, to sense a movement of the touch pen 1. Then, a contact sensing signal by the contact sensing unit 5 of the touch pen 1 and a position signal from the movement sensing unit 11 are transmitted to a host PC 20 as an information processing apparatus via wired or wireless lines.

The contact sensing unit 5 judges contact between a screen and a pen tip, and includes a pen core 5b in the touch pen 1 and a conductive rubber 5a mounted to an end of the pen core 5b. As the contact sensing unit 5, the following sensors can be used: a switch; and a distortion sensor that utilizes the fact that a casing and a core are deformed due to a force applied to the touch pen 1 at contact of a touch pen, for example. When the touch pen 1 touches a screen, the pen core 5b is pressed against a screen. Accordingly, the conductive rubber 5a located on an opposite side of the pen core 5b is compressed, resulting in a change of a resistance value. Thus, contact is sensed. A push switch may be used instead of the conductive rubber 5a. The power source 3 supplies power to the drive unit 2, the calculation unit 4, the contact sensing unit 5, or the like. The calculation unit 4 controls vibration of the drive unit 2 disposed to the touch pen 1. Furthermore, the calculation unit 4 performs judgment on a drawing mode of the touch pen 1; judgment based on information acquired by the movement sensing unit 11, the contact sensing unit 5, and the like; control of output of noise sound described later; and the like.

The movement sensing unit 11 detects a position of a touch pen by sensing a time change of a pen tip position on a screen of the drawn apparatus 10. A position of the touch pen 1 on a screen is transmitted to the host PC 20. Usually, a position of a pen tip is measured by the movement sensing unit 11 in a sampling cycle of approximately from tens to 100 Hz. Therefore, a movement of the touch pen 1 is detected by checking a change of pen tip position information transmitted to the host PC 20. In this case, an absolute position of the touch pen 1 in a screen is not necessary, and similarly to a mouse, only a relative movement is required to be acquired. Movement of the touch pen 1 can also be detected by a compact camera, a PSD (Position Sensing Device), an acceleration sensor, and a gyro sensor each mounted to a pen tip.

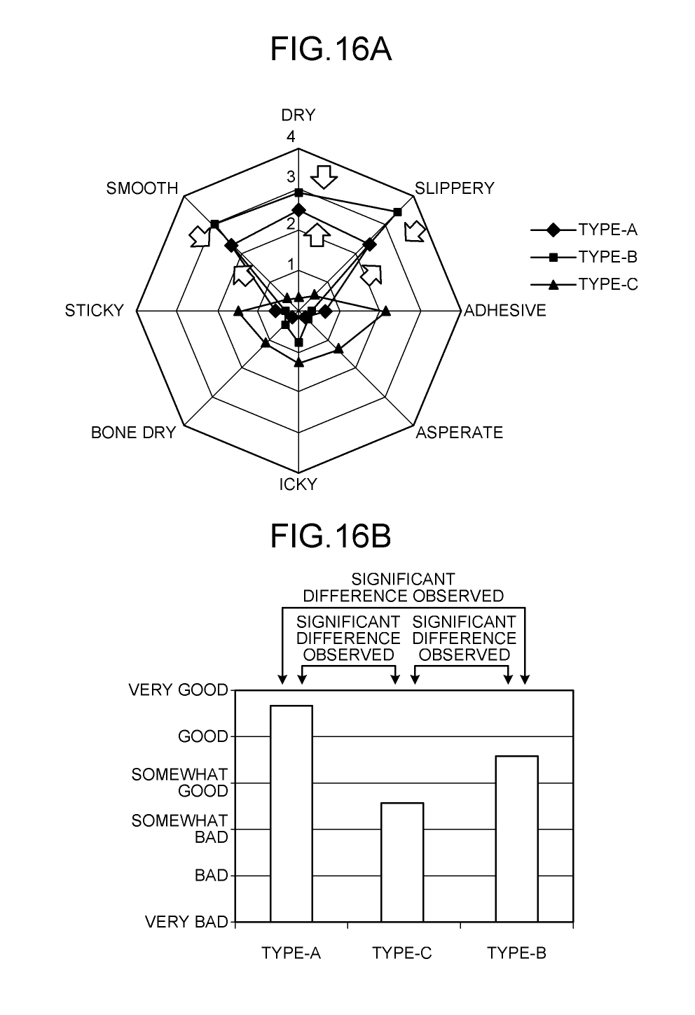

The drive unit 2 is hardware for vibrating the touch pen 1. As the drive unit 2, a motor and a piezoelectric element can be used. Usually, in the touch pen 1, a favorable writing taste is felt when there is appropriate resistance during drawing. For example, three types of pairs of a pen core and a paper sheet were prepared (Type-A: anti-glare sheet+felt core, B: glass+plastic core, C: soft film+felt core), and a questionnaire survey was conducted on about 30 subjects regarding mimetic words about a writing feeling and easiness of writing. The results are illustrated in FIGS. 16A and 16B. As seen from a viewpoint of writing easiness illustrated in FIG. 16B, Type-A is the best, and Type-B is the next best. As seen from FIG. 16A, a user tends to prefer a writing feeling having an adequate friction sense (for example, smooth, dry, and slippery) like Type-A and Type-B. Therefore, an adequate friction sense may be desirably imparted to the touch pen 1. The drive unit 2 is provided for imparting an adequate friction sense to the touch pen 1. When the drive unit 2 is a motor, a forward rotation and a reverse rotation may be switched alternately and quickly to generate vibration. Vibration can also be generated by using a decentered weight. However, in this case, there is whirling vibration with respect to a motor axis, resulting in vibration of a whole of the touch pen 1 in some cases. When a whole of the touch pen 1 vibrates with large amplitude, a writing feeling can become uncomfortable. As described later, more moderate friction sense can be imparted when vibration is in an appropriate range. Therefore, a method of alternately repeating a rotation in one direction (forward rotation) and a rotation in an opposite direction to the forward rotation (reverse rotation) is preferred.

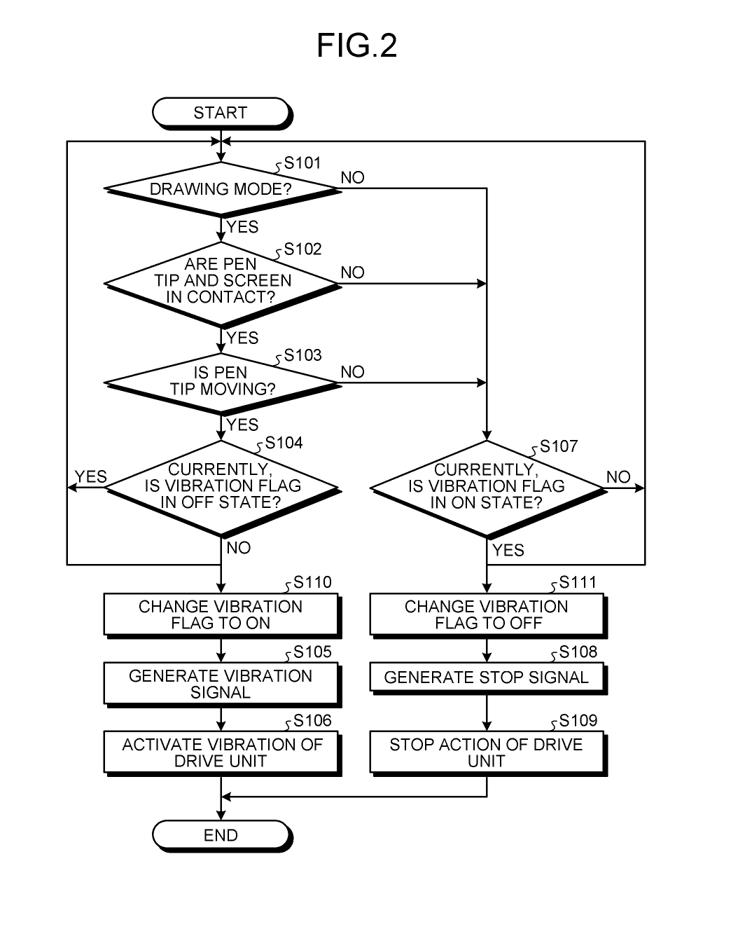

FIG. 2 is a flow chart illustrating a flow of processing of vibration control of a touch pen 1 in the calculation unit 4. First, the calculation unit 4 judges whether or not the touch pen 1 is in a drawing mode (step S101). The drawing mode is a mode that is activated by pressing a drawing mode switch disposed to the touch pen 1 and actually enables trace drawn on a screen of the drawn apparatus 10 to be left. Other methods of switching to a drawing mode include pressing a drawing mode switch on a screen of the drawn apparatus 10, and automatically activating a drawing mode when a pen tip enters within a drawing area of a screen.

When the touch pen 1 is judged to be in a drawing mode (step S101: Yes), the calculation unit 4 checks output of the contact sensing unit 5 and the movement sensing unit 11 transmitted to the host PC 20, and judges whether or not a pen tip is in contact with a screen (step S102), and whether or not the touch pen 1 is moving near a screen (step S103).

When the calculation unit 4 judged that a pen tip is in contact with a screen (step S102: Yes), and the touch pen 1 is moving near a screen (step S103: Yes), the calculation unit 4 judges whether or not a vibration flag of the touch pen 1 is OFF (step S104). The vibration flag is a setting information for determining whether or not to vibrate the touch pen 1. When a vibration flag of the touch pen 1 is judged to be OFF (step S104: Yes), a vibration flag is changed to an ON state, and the processing returns to step S101 again while moving to step S105 (step S110). Thereafter, the calculation unit 4 generates a signal of a predetermined vibration pattern (step S105), and transmits the vibration pattern signal to the drive unit 2 for activation (step S106). On the other hand, when vibration is judged not to be in an OFF state (step S104: No), the processing returns to step S101.

When the touch pen 1 is judged not to be in a drawing mode (step S101: No), when a pen tip is judged not to be in contact with a screen (step S102: No), and when a pen tip is judged not to be moving (step S103: No), the calculation unit 4 judges whether or not a vibration flag of the touch pen 1 is in an ON state (step S107). When a vibration flag of the touch pen 1 is judged to be in an ON state (step S107: Yes), the calculation unit 4 changes a vibration flag to OFF, and the processing returns to step S101 while moving to step S108 (step S111). Thereafter, the calculation unit 4 generates a stop signal (step S108), and transmits a vibration OFF signal to the drive unit 2 for terminating action of the drive unit 2 (step S109). Thus, only when a pen tip is in contact with a screen and moving near the screen, a brush stroke is actually drawn on the screen, and vibration associated with drawing is transmitted to a fingertip. Therefore, a user can experience a skin sensation of a fingertip and a motion sense of a hand moving the touch pen 1, and can feel roughness of a screen in contact with the touch pen 1. When a vibration flag of the touch pen 1 is judged not to be in an ON state (step S107: No), the processing returns to step S101.

When a judgment on whether or not the touch pen 1 is in a drawing mode (step S101), a judgment on whether or not a pen tip is moving (step S103), and a judgment on whether or not a pen tip is in contact with a screen (step S102) are made on the host PC 20 side, the host PC 20 may generate a vibration pattern of the touch pen 1 in step S105 and step S108, and transmit the generated vibration pattern to the calculation unit 4 of the touch pen 1 via wireless or wired lines. Then, the touch pen 1 having received a vibration pattern performs processing of execution or termination of vibration action of the drive unit 2.

When at least one of a judgment on whether or not a pen tip is moving (step S103) and a judgment on whether or not a pen tip is in contact with a screen (step S102) is made on the touch pen 1 side, a judgment on whether or not the touch pen 1 is in a drawing mode (step S101) and a judgment on whether or not a vibration flag of the touch pen 1 is in an ON state or in an OFF state (step S104 and step S107) are made on the host PC 20 side. Then, judgment results are transmitted to the calculation unit 4 of the touch pen 1.

Then, the calculation unit 4 in the touch pen 1 generates an actual vibration pattern or an actual vibration termination pattern according to a vibration situation of ON or OFF at that time, that is information acquired from the host PC 20 (steps S105 and S108), to activate or stop the drive unit 2 (steps S106 and S109). Notably, when both a judgment on whether or not a pen tip is moving (step S103) and a judgment on whether or not a pen tip is in contact with a screen (step S102) are made on the touch pen 1 side, information to be transmitted from the host PC 20 to the calculation unit 4 in the touch pen 1 is only on whether or not the touch pen 1 is in a drawing mode. That is, only when a mode is to be changed, the mode may be transmitted. At this time, the calculation unit 4 in the touch pen 1 also determines action of the drive unit 2.

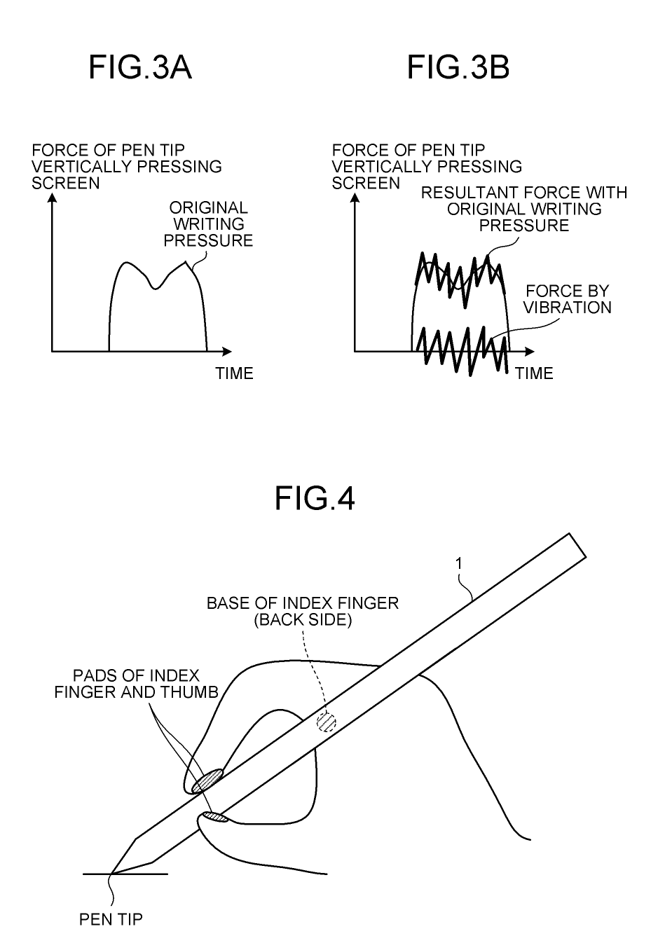

Next, a position where the drive unit 2 is disposed in the touch pen 1 will be described. FIGS. 3A and 3B are drawings for explaining vibration between a pen tip and a screen, and roughness perceived when a user performs drawing. FIG. 3A illustrates a force of a pen tip pressing a screen versus time. For example, when the drawn apparatus side vibrates, the vibration is also added to a tactile feeling to a user's finger acting as a counteraction to the force of a pen tip vertically pressing a screen (FIG. 3B). In this manner, vibration between a pen tip and a screen influences a friction sense perceived by a finger during drawing. Therefore, the drive unit has been arranged near a pen tip that is an end of the touch pen 1, in order to vibrate a pen tip. Here, FIG. 4 is an example of fingers of a hand holding the touch pen 1, particularly in a case of a right-handed user. As understood from this, when vibration is transferred to pads of an index finger and a thumb holding the touch pen 1, roughness (that is, a writing feeling) during drawing can be felt. The touch pen 1 is sometimes held by a thumb, depending on a way to hold the touch pen 1. In such a case, the same effects can be obtained even with a pad of a thumb. Inhibiting vibration from being transferred to a base of an index finger supporting the touch pen 1 is important. Vibration of a base of an index finger causes a tactile feeling that the touch pen 1 is entirely vibrating. Accordingly, a sense of drawing on a paper sheet with the touch pen 1 cannot be obtained. For practical purposes, there is a problem in which unintended vibration occurring in a pen tip causes a difficulty of a user to write, in particular, in a case of handwriting, such as drawing of letters. Therefore, mechanism is preferably as simple as possible, and vibration is preferably transferred to only a finger holding the touch pen 1 during drawing.

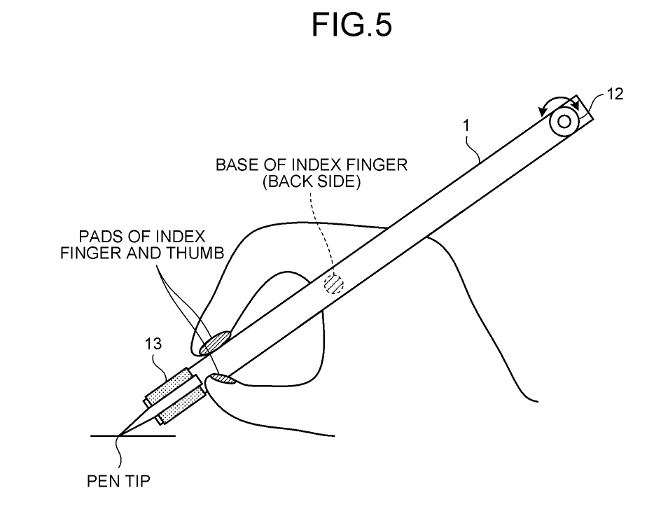

FIG. 5 is a diagram illustrating an example of an arrangement aspect of a drive unit to the touch pen 1. In FIG. 5, a rotating vibrator 12 causing vibration by rotation like a motor is disposed as a drive unit to an end opposite to a pen tip of the touch pen 1. When the rotating vibrator 12 is arranged so that a rotation axis is parallel to an axis of the touch pen 1, a whirling vibration around a pen axis is developed. As a result, vibration is transferred around a base of an index finger supporting the touch pen 1. Here, the rotating vibrator 12 desirably rotates in such a manner that one direction and the other direction indicated in the figure are alternately repeated. Thus, an aspect of the rotating vibrator 12 rotating in an alternate manner is preferred since a frequency of 10 to 300 Hz can be achieved with a compact apparatus. By providing appropriate frequency, an adequate friction sense can be imparted. Therefore, in this case, by not placing an axis of the rotating vibrator 12 in parallel to an axis of a touch pen and arranging a rotation surface in a direction indicated by arrows in FIG. 5, vibration is transferred to a pad of an index finger and becomes difficult to be transferred to a base of an index finger. Moreover, by arranging a cushioning material 13 between a pen core and a casing of the touch pen 1, vibration can become difficult to be transferred to a pen core.

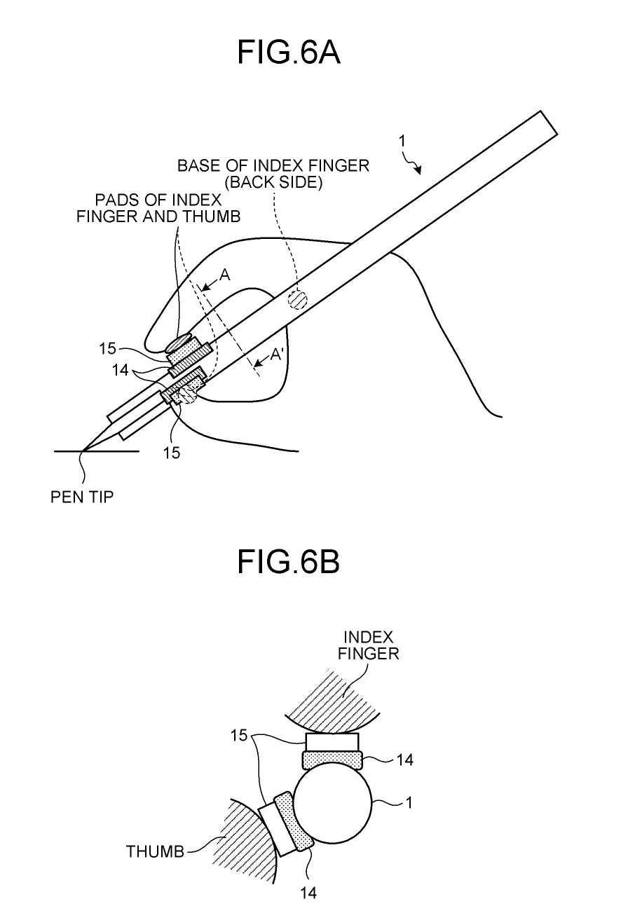

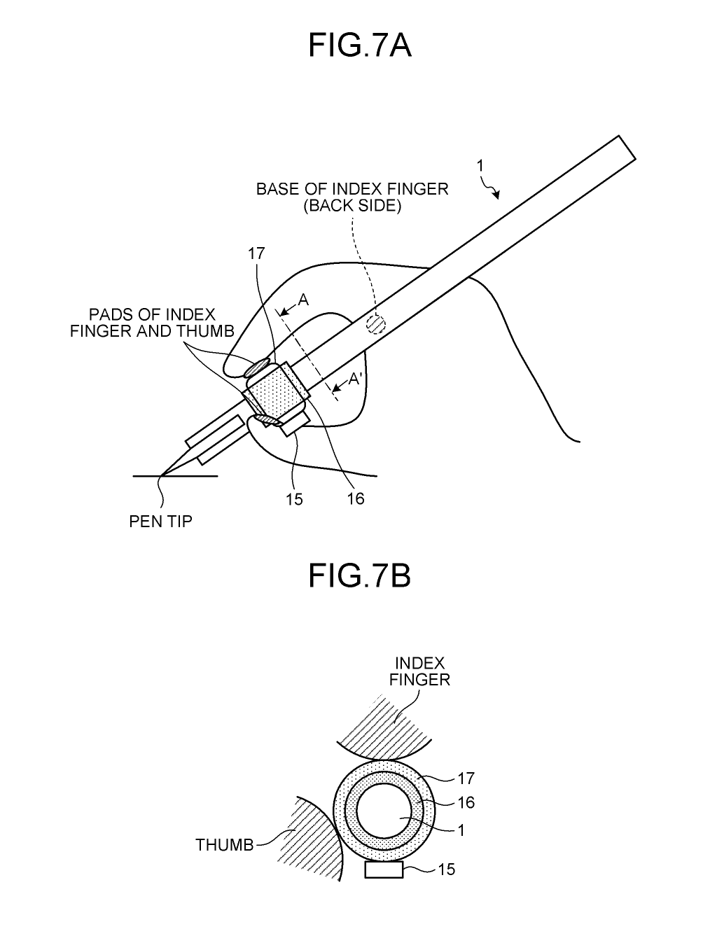

FIGS. 6A and 6B are diagrams illustrating another example of an arrangement aspect of a drive unit to the touch pen 1. In this example, as illustrated in FIG. 6A, a vibrator 15 as a drive unit is arranged in a position in contact with at least one of an index finger pad and a thumb pad both holding the touch pen 1. That is, a cushioning material 14 is desirably arranged between the vibrator 15 and a casing of the touch pen 1. FIG. 6B is an enlarged view of a touch pen and a drive unit. By arranging the cushioning material 14 on an inner side of the vibrator 15 as a drive unit, vibration is transferred to a whole of the touch pen 1. Accordingly, easiness of drawing can be inhibited from decreasing. Alternatively, as illustrated in FIGS. 7A and 7B, the vibrator 15 and a ring-like member 17 may be provided. The ring-like member 17 is fitted around the touch pen 1. Vibration from the vibrator 15 is transferred to the ring-like member 17. Then, a whole of the ring-like member 17 vibrates. Thus, vibration can always be transferred to a finger when the touch pen 1 is held at any angle. Furthermore, since the number of vibrators does not need to be the number of locations of a support part on a touch pen, the number of components can also be reduced. Moreover, a cushioning material 16 is disposed between the ring-like member 17 and a casing of the touch pen 1. In a method of directly transferring vibration to a finger by a vibrator, a vibration direction may be any direction.

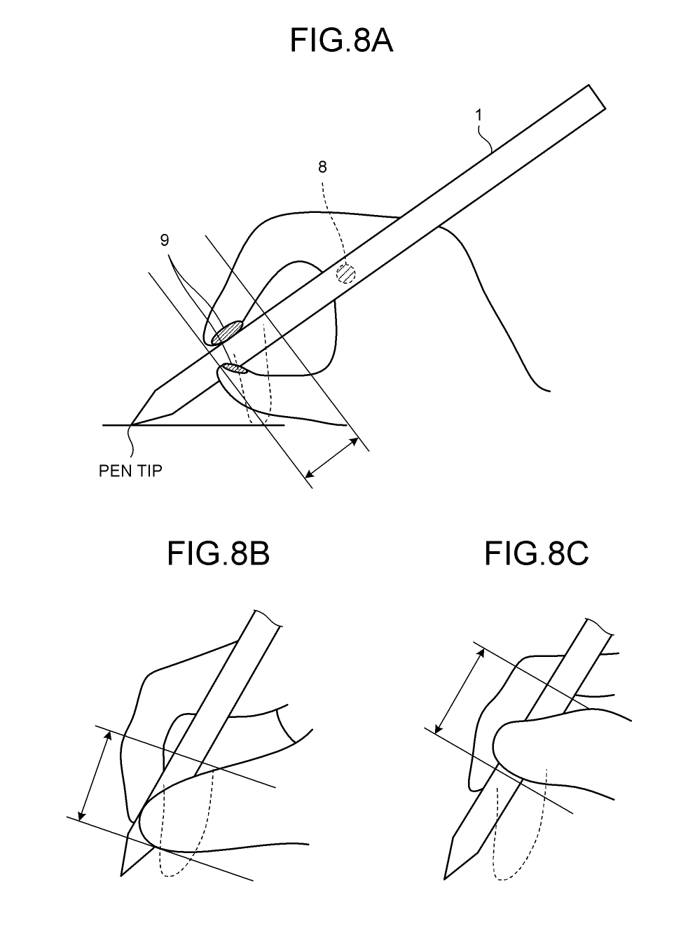

FIGS. 8A to 8C are diagrams for explaining a position of arranging a drive unit in the touch pen 1. As illustrated in FIG. 8A, a user holds the touch pen 1 at a first contact point 9 consisting of an index finger and a thumb and at a second contact point 8 corresponding to a base of an index finger. Here, a position of each of the first contact point 9 and the second contact point 8 differs depending on a way of holding the touch pen 1. For example, the position differs between a case of holding the touch pen 1 in a position close to a pen tip as in FIG. 8B, and a case of holding the touch pen 1 in a position far from a pen tip as in FIG. 8C. A position of disposing a vibrator as a drive unit is desirably between the first contact point 1 and the second contact point 8.

A position of arranging a vibrator will be described more specifically. As discussed above, a position of holding the touch pen 1 differs depending on a person. A hand of a normal adult male has a size of about 80 mm. Therefore, a position of disposing a vibrator is desirably within a range of 10 mm to 80 mm from an end (pen tip) of a casing of the touch pen 1. The position of not less than 80 mm from a pen tip is not desirable, since a drive unit can be directly brought into contact with a base of an index finger. The position of less than 10 mm from a pen tip causes a pen tip to be directly subjected to vibration. Therefore, a writing feeling can be impaired.

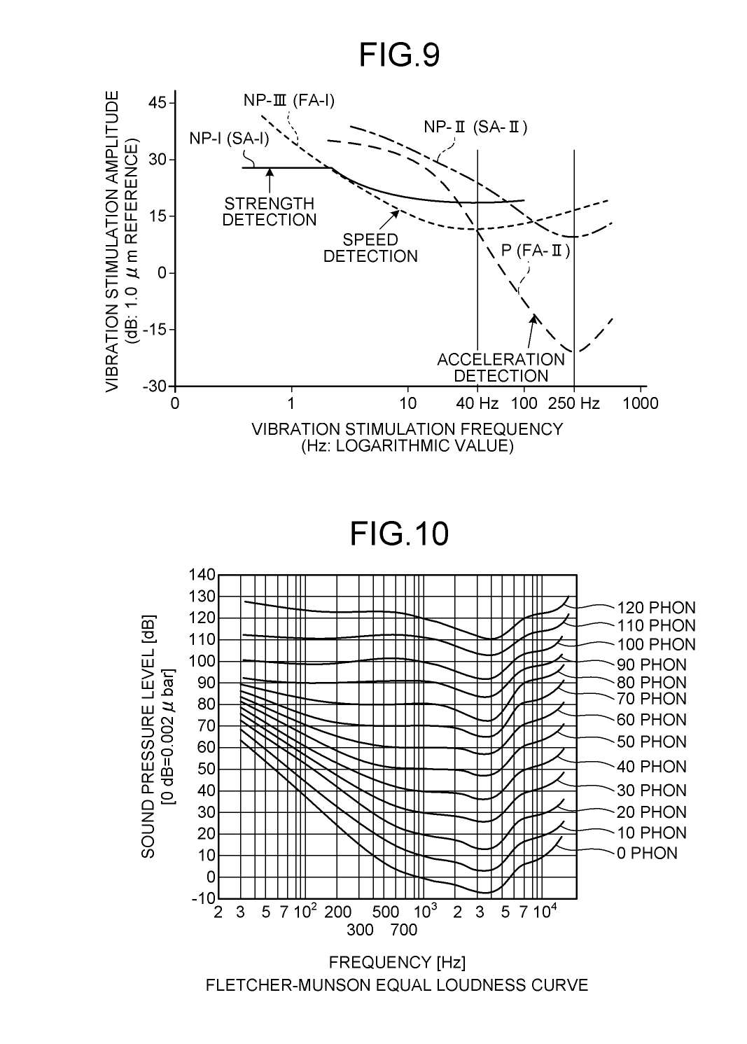

Next, a vibration signal of the drive unit 2 will be described in detail. In FIG. 9, characteristics of an organ receptor of a tactile sense on hand skin is illustrated. There is a mechanoreceptor in a hand palm side of skin. The mechanoreceptor is classified as follows based on a difference of a time change of a response to a skin deformation stimulation as well as characteristics of a receptive field width. The mechanoreceptor is classified into Slowly Adapting (SA) type responding to strength of stimulation and Fast Adapting (FA) type responding to a time change of stimulation, as well as I type having a narrow receptive field and II type having a wide receptive field. NP-1 (SA-1) is Merkel cells; NP-2 (SA-2) is Ruffini endings; NP-3 (FA-1) is Meissner corpuscles; and P(SA-1) is Pacinian corpuscles. Characteristics relating to a skin sense during writing by hand include speed detection and acceleration detection. With respect to speed detection, a peak of sensitivity exists around 40 Hz. Also, with respect to acceleration detection, a peak of sensitivity exists at 250 to 280 Hz.

FIG. 10 is a diagram illustrating human auditory characteristics. A vertical axis of the graph represents a sound pressure level, and a horizontal axis represents frequency. In FIG. 10, sound pressure levels applicable for respective frequencies are assigned for each of 0 to 120 phon as a loudness that can be actually heard by a human ear. FIG. 10 indicates that even at the same sound pressure level, as frequency is higher, larger sound is experienced by a human ear. In human auditory characteristics, sensitivity is low in a low tone range while being high at not lower than 300 Hz. In view of a fact that background noise in a quiet room has a sound pressure of approximately 40 dB, not higher than 30 phon that is a loudness experienced without causing awareness of sound is desired. Furthermore, at least one peak vibration frequency between 10 to 300 Hz is desirably provided so that only vibration can be perceived. In this case, at a vibration frequency of lower than 10 Hz, vibration becomes difficult to be perceived. Therefore, a vibration frequency is preferably at least about 10 Hz.

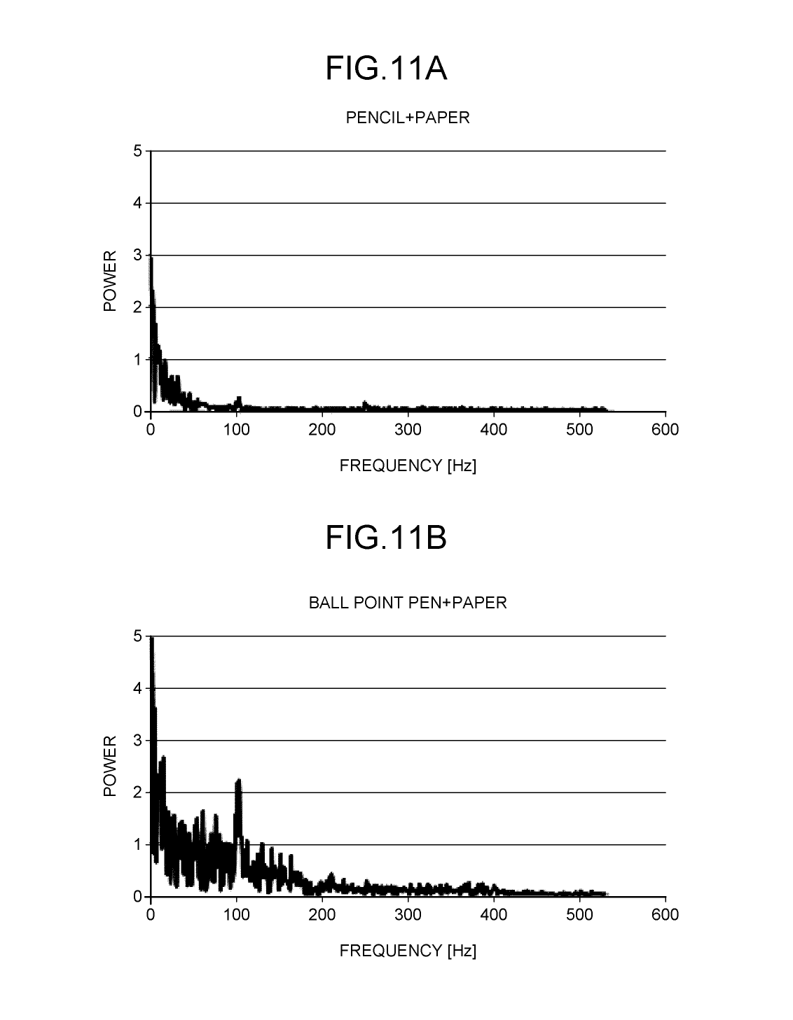

Here, as a touch pen, there is an application of virtually changing a touch pen into one of various types of touch pens such as a pencil, a ball-point pen, and a magic pen. For example, when a user selects a pencil, a tactile sensation of a pencil can be obtained. Also, when a user selects a ball-point pen, a tactile sensation of a ball-point pen can be obtained. For example, FIG. 11A illustrates power versus frequency when a pencil is used as a drawing device and drawing is performed on a paper sheet. Similarly, FIG. 11B illustrates an example when a ball-point pen is used as a drawing device and drawing is performed on a paper sheet. When comparing FIG. 11A with FIG. 11B, a ball-point pen has larger vibration power. Therefore, the calculation unit 4 is configured to control the drive unit 2 so that vibration becomes a little larger when a user selects a ball-point pen, and vibration becomes a little smaller when a user selects a pencil. Furthermore, a display on a screen may be changed according to a selected touch pen so that drawing with a virtual distinction of a pen type is enabled.

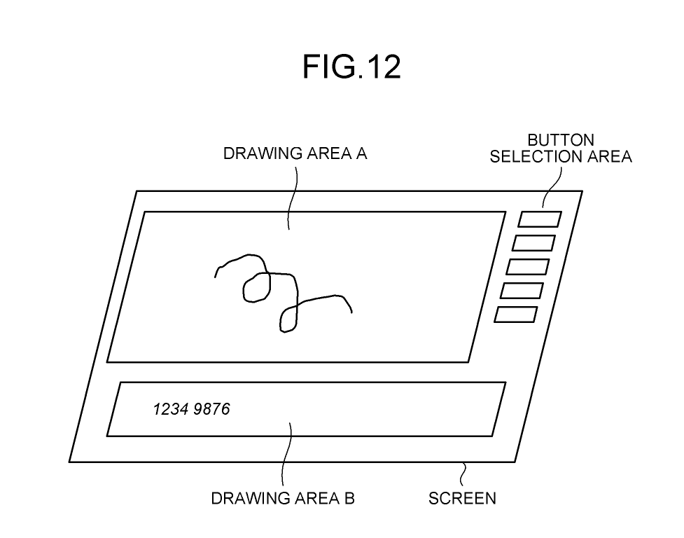

As illustrated in FIG. 12, a region on a screen of the drawn apparatus 10 may be divided into a drawing area A, a drawing area B, and a button selection area. In this case, different vibration patterns may be imparted to respective drawing actions in the drawing area A and the drawing area B. When the button selection area is touched, vibration may not be caused. In this case, these can be realized by changing a vibration pattern to be generated, based on a position information of the movement sensing unit 11 acquired by the calculation unit 4 or the host PC 20. Furthermore, a vibration pattern may be changed according to a line type including vertical and horizontal lines, color, and thickness; a direction (a brush-moving direction) of a stroke that is trace of a touch pen; a position of a displayed object; and the like. For example, resistance between a touch pen and a screen may be changed according to a stroke direction. Accordingly, a virtual writing feeling of a new tactile sensation such as directional properties of a paper sheet and a difference in paper quality can be provided. Furthermore, a virtual region can be defined by a writing feeling with a touch pen.

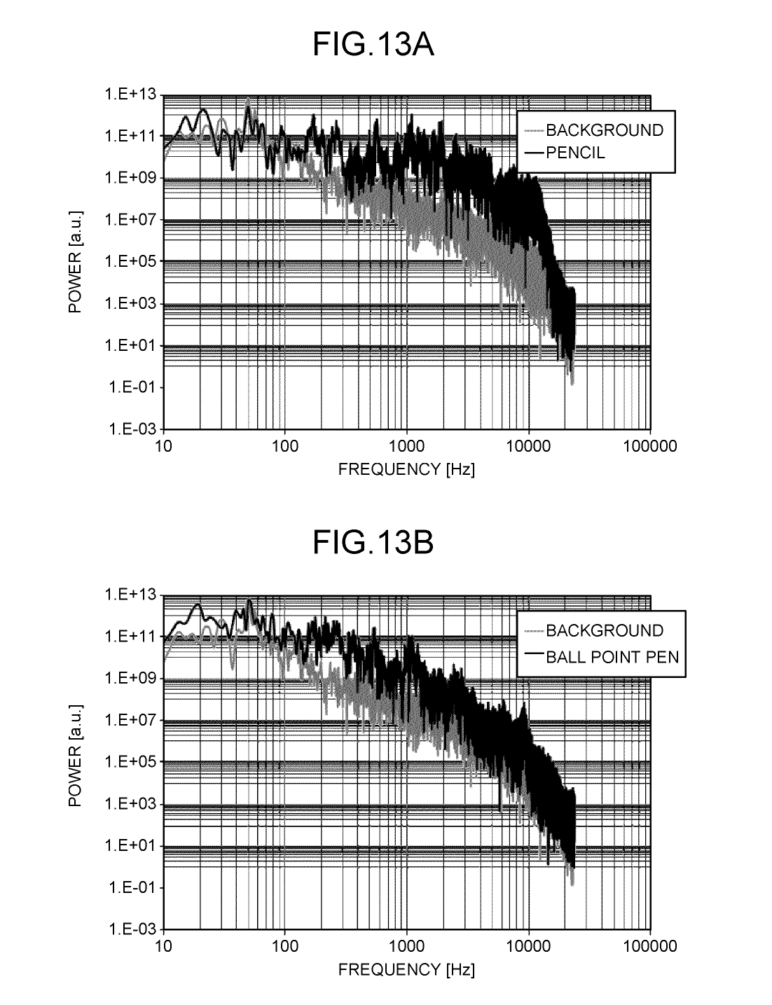

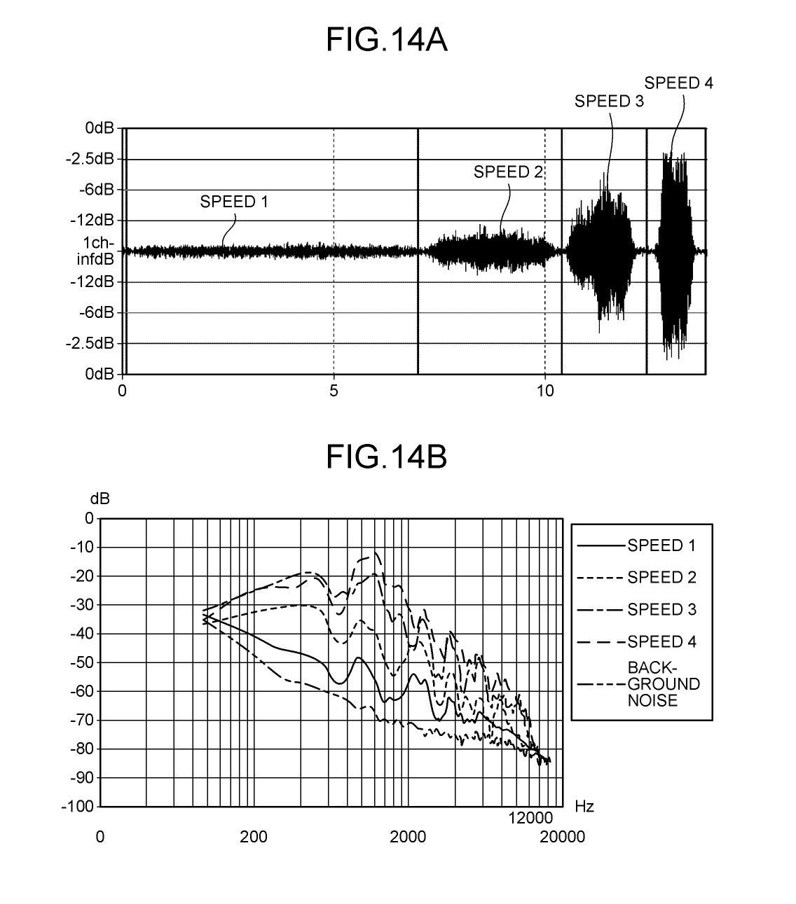

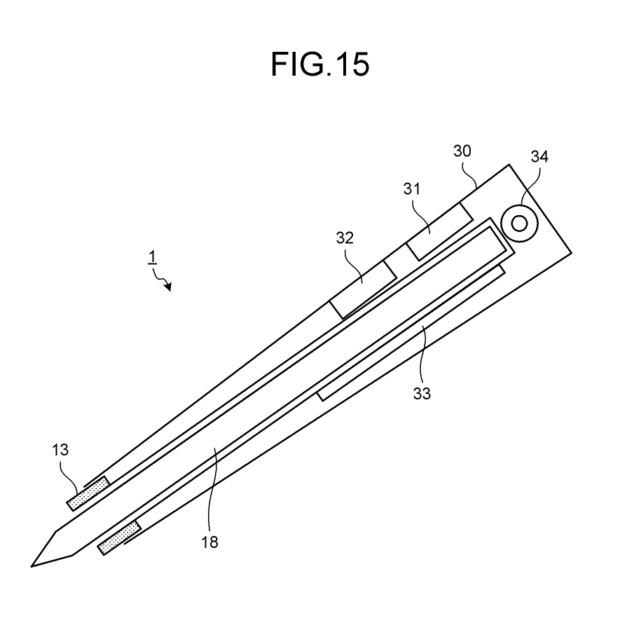

Furthermore, the drawing apparatus 1 may include a sound output unit. The sound output unit is controlled by a sound control unit further provided to the calculation unit 4. For example, in addition to the above-described vibration, random noise sound may be output according to a position of the touch pen 1 in motion, so that a sense of reality can be further increased. FIGS. 13A and 13B are graphs illustrating spectra of sound generated by a paper sheet when a pencil (FIG. 13A) and a ballpoint pen (FIG. 13B) are actually used. In brief, the graphs illustrate power versus frequency, and demonstrate random noise sound having random frequency and amplitude. With this random noise sound, a tactile feeling of drawing can be produced by changing loudness and frequency bands according to a moving speed of a touch pen. For example, FIG. 14A is sound data obtained when a line was drawn on a paper sheet with a ball-point pen (Zebra (registered trademark):FLOS). The measurement was performed by changing a brush-moving speed (vertical axis: amplitude, horizontal axis: time, brush-moving speed from left: approximately 20 mm/s, approximately 60 mm/s, approximately 90 mm/s, and approximately 130 mm/s). FIG. 14B is a result of a frequency analysis for each brush-moving speed. As seen from this diagram, with respect to this ball-point pen, a difference in sound pressure level occurs among the speeds in a range of 100 Hz to 12000 Hz with a center around 1 to 2 KHz. Therefore, the calculation unit 4 may perform calculation so that a sound pressure level is increased or decreased depending on a brush-moving speed in a range of 100 Hz to 12000 Hz with a center around 1 to 2 KHz. The calculation unit 4 adjusts amplitude to become larger as a speed increases. In this case, sound may be increased by 10 to 15 dB as a speed is approximately doubled. Here, sound corresponding to a position of a touch pen can be realized by changing a phase difference between two speakers. By controlling sound, a writing feeling with an increased sense of reality can be obtained. Although a moving speed of a touch pen has been described as an example above, an acceleration, a moving direction (a stroke direction), and the like may be used according to a method of detecting movement.

When a noise having large power on a low band side, such as pink noise, red noise, and brown noise, is used as random noise, a sense close to an actual sound of a touch pen is experienced. By changing the sound according to a touch pen type in a similar manner to vibration, more types of touch pens can be expressed. In order to change a pen type, for example, the touch pen 1 or a tablet screen may be provided with a pen selection button. Each time the button is pressed, a pencil mode, a ballpoint pen mode, a marker pen mode, a magic pen mode, and the like may be sequentially switched.

The method of controlling vibration described herein can also be realized through an attachment to an existing electronic touch pen. For example, as illustrated in FIG. 15, an attachment 30 includes a receiver 31 receiving information regarding initiation and termination of vibration, a drive unit 34 imparting certain vibration based on output of the receiver 31, a battery 33, and a calculation unit 32. With the attachment 30 capable of being mounted in a rear side of the center of gravity of a stylus 18, the same functions as described herein can be provided to existing electronic touch pens and ball-point pens. For example, the attachment 30 can be mounted to a touch pen or a stylus of an existing digitizer such as WACOM Cintiq (registered trademark), in a manner of covering this touch pen.

Calculation Unit 4

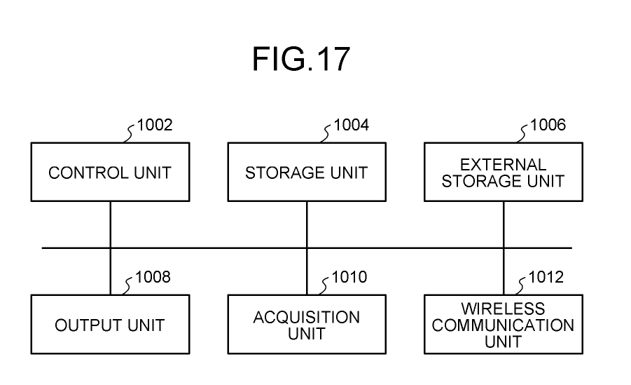

FIG. 17 is a diagram illustrating an example of the calculation unit 4 of the drawing apparatus according to the above-described embodiments. The calculation unit 4 according to the above-described embodiments may be built in the touch pen 1, or may be provided to the drawn apparatus 10, the host PC 20, or the like.

When provided to the drawn apparatus 10 or the host PC, the calculation unit 4 includes a control unit 1002 such as a CPU, a storage unit 1004 such as a ROM and a RAM, an external storage unit 1006 such as a HDD, an output unit 1008 outputting information for controlling the drive unit 2 or the sound output unit, and an acquisition unit 1010 acquiring information regarding a moving distance, trace, or the like of the touch pen 1. Also, the calculation unit 4 has a structure with a usual computer utilized. Furthermore, the calculation unit 4 may have an information processing apparatus performing, for example, acquisition of information regarding a moving distance, trace, or the like from the touch pen 1. Especially, when performed via wireless lines or the like, a wireless communication unit 1012 may be provided to the touch pen 1, the drawn apparatus 10, the host PC, and the like.

Processing to be executed in the calculation unit 4 according to the above-described embodiments may be stored as a program. A program to be stored is recorded in a file of an installable or executable format in a recording medium readable by a computer, such as a CD-ROM, a CD-R, a memory card, a DVD (Digital Versatile Disk), and a flexible disk (FD). Thus, the recorded program is provided.

Furthermore, a program to be executed in the calculation unit according to the above-described embodiments may be provided by storing the program on a computer connected to a network such as the Internet and allowing a user to download the program via a network. Also, a program to be executed in the wireless communication unit according to the above-described embodiments and variations may be provided or distributed via a network such as the Internet. Also, a program to be executed in the wireless communication unit according to the above-described embodiments and variations may be provided by previously incorporating the program into a ROM or the like.

A program to be executed in the calculation unit according to the above-described embodiments has a module structure for realizing the above-described units on a computer. As actual hardware, a CPU retrieves a program from a HDD onto a RAM, and executes the retrieved program to realize the above-described units on a computer.

Here, the above-described embodiments are not limited by themselves, and can be practiced by modifying the components in a range without departing from the gist in an implementation stage. Moreover, various inventions can be formed by appropriately combining a plurality of components disclosed in the above-described embodiments. For example, some components may be deleted from all of the components shown in the embodiments. Furthermore, components of different embodiments may be appropriately combined.

For example, the steps in the flow chart of the above-described embodiments may be changed in execution order, may be plurally executed in a simultaneous manner, or may be executed in a different order for each implementation, unless such changes or execution are contrary to the nature of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drawing apparatus, comprising:
a casing comprising a tip; and
a drive unit configured to vibrate the drawing apparatus, the drive unit being positioned within a range of 10 to 80 mm from the tip.

2. The drawing apparatus of claim 1, further comprising:
a contact sensor configured to sense contact between the drawing apparatus and a device; and
a drive controller configured to drive the drive unit when:
a drawing mode is set,
contact between the drawing apparatus and the device is sensed, and
movement of the drawing apparatus on the device is sensed.

3. The drawing apparatus of claim 2, wherein
the drive controller is configured to stop driving the drive unit when at least one of:
the drawing mode is not set,
contact between the drawing apparatus and the device is not sensed, and
movement of the drawing apparatus on the device is not sensed.

4. The drawing apparatus of claim 1, wherein
the drive unit has at least one peak vibration frequency between 10 to 300 Hz.

5. The drawing apparatus of claim 1, further comprising a cushioning material between the drive unit and the casing of the drawing apparatus configured to reduce a transfer of vibration caused by the drive unit.

6. The drawing apparatus of claim 1, wherein
the drive unit comprises a rotating vibrator configured to vibrate while alternately changing rotation directions.

7. The drawing apparatus of claim 1, wherein
the drive controller is configured to control a vibration pattern that causes the drive unit to vibrate, according to a selected drawing apparatus type.

8. The drawing apparatus of claim 1, further comprising:
a sound output unit configured to generate sound during movement of the drawing apparatus.

9. The drawing apparatus of claim 8, further comprising
a sound controller configured to control the sound output unit, wherein
the sound controller is configured to change at least one of an amplitude and a frequency of the sound according to at least one of a speed, an acceleration, and a direction of sensed movement of the drawing apparatus.

10. The drawing apparatus of claim 9, wherein
the sound controller is configured to change at least one of the amplitude and the frequency of the sound according to a selected drawing apparatus type.

11. A drawing system, comprising:
a drawing apparatus including a drive unit and a casing having a tip, the drive unit being configured to vibrate the drawing apparatus and positioned within a range of 10 to 80 mm from the tip;
a display device including a screen on which the drawing apparatus is configured to draw; and
an information processing apparatus configured to enable communication between the drawing apparatus and the display device.
